(19) United States
(12) Patent Application Publication
(10) Pub. No.: US 2012/0082562 A1
(43) Pub. Date: Apr. 5, 2012

(54) Wind turbine

(76) Inventor: Andrey KOTLER, Nahariya (IL)

(21) Appl. No.: 12/898,182

(22) Filed: Oct. 5, 2010

(51) Int. Cl. F03D 3/06; F03D 11/00

(52) U.S. Cl. 416/93 R; 290/55

(57) ABSTRACT

A turbine includes a plurality of blades distributed about a hub and configured to rotate about an axis through the hub when subjected to a flowing fluid. The turbine further includes at least one fluid intake opening located near the hub. A proximal end of each of a plurality of conduits opens to the fluid intake opening. Each conduit extends toward one of the blades and includes at its distal end at least one fluid outlet configured to direct a fluid flow substantially parallel to a leading edge of the blade.

### FIELD OF THE INVENTION

The present invention relates to wind turbines.

### BACKGROUND OF THE INVENTION

A wind turbine may be used to harness wind energy and convert it to rotational energy of a rotor shaft. Typically, a plurality of blades of the wind turbine is configured to rotate in the presence of a wind. The rotor shaft may be coupled to an apparatus, thus powering the apparatus. For example, a rotor shaft of a wind turbine may be coupled to a rotor of an electrical generator so as to generate electrical power.

The various designs for wind turbines that have been described may be classified into two broad classifications: horizontal axis and vertical axis. A vertical axis wind turbine (VAWT) may have advantages over horizontal axis designs. For example, there is generally no need to orient a vertical axis wind turbine in a particular orientation with respect to the wind. Thus, a vertical axis wind turbine may facilitate harnessing wind energy at a location where wind direction is variable. In addition, a vertical axis wind turbine may be situated closer to the ground than a similar sized horizontal axis wind turbine, since the vertical axis wind turbine need not accommodate a vertical blade. Also, a generator or other apparatus operated directly by a rotor shaft of a vertical axis wind turbine may be situated close to the ground

vertical axis wind turbine configurations have been described in which air flow through a hollow section of the blades, or of arms that connect to the blades, is utilized to improve efficiency. For example, Chinese patents CN 101509464 and CN 1727671, as well as Herr in WO 2006/027245, describe vertical axis wind turbine configurations in which wind enters and is redirected out of a rotating blade as a jet flow to augment the forces that cause the blades to rotate. Cyrus et al. in U.S. Pat. No. 4,504,192, Fiorini in EP 1335130, and Faller in DE 10126814 describe vertical axis wind turbine configurations in which such air flow is used to improve aerodynamic properties of the blades.

It is an object of the present invention to provide a vertical axis wind turbine configuration with improved efficiency.

Other aims and advantages of the present invention will become apparent after reading the present invention and reviewing the accompanying drawings.

### SUMMARY OF THE INVENTION

There is thus provided, in accordance with some embodiments of the present invention, a turbine device. The turbine device includes a plurality of blades distributed about a hub and configured to rotate about an axis through the hub when subjected to a flowing fluid. The device also includes at least one fluid intake opening located near the hub and a plurality of conduits. A proximal end of each conduit opens to the fluid intake opening, each conduit extending toward one of the blades and each conduit including at its distal end at least one fluid outlet configured to direct a fluid flow substantially parallel to a leading edge of the blade.

Furthermore, in accordance with some embodiments of the present invention, the plurality of blades includes at least three blades.

Furthermore, in accordance with some embodiments of the present invention, the plurality of blades comprises five or seven blades.

Furthermore, in accordance with some embodiments of the present invention, the axis is substantially vertical.

Furthermore, in accordance with some embodiments of the present invention, the blades are configured to rotate when the fluid is air.

Furthermore, in accordance with some embodiments of the present invention, the fluid intake opening is located on the hub.

Furthermore, in accordance with some embodiments of the present invention, the device includes a plurality of arms, each arm connecting one of the blades to the hub.

Furthermore, in accordance with some embodiments of the present invention, each of the arms includes one of the conduits.

Furthermore, in accordance with some embodiments of the present invention, each arm includes at least two fluid outlets.

Furthermore, in accordance with some embodiments of the present invention, two of the fluid outlets are configured to direct the fluid flow in substantially opposite directions.

Furthermore, in accordance with some embodiments of the present invention, the device includes an electrical generator.

Furthermore, in accordance with some embodiments of the present invention, the device includes a transmission for converting rotation of the blades to rotation of a rotor of the generator.

Furthermore, in accordance with some embodiments of the present invention, the transmission includes a shaft connecting the hub to the rotor.

Furthermore, in accordance with some embodiments of the present invention, the electrical generator is mounted on a post for supporting the central hub.

Furthermore, in accordance with some embodiments of the present invention, the device includes a post for supporting the hub.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 shows a vertical axis wind turbine in accordance with embodiments of the present invention.

FIG. 2 is an enlarged view of a section of the vertical axis wind turbine shown in FIG. 1, illustrating details of the blade and arm structure.

FIG. 3 is a cutaway view of the blade and arm structure shown in FIG. 2 illustrating air flow within the structure.

### DETAILED DESCRIPTION OF EMBODIMENTS

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

A fluid-powered turbine in accordance with embodiments of the present invention includes a plurality (typically three or more) of blades configured to rotate around an axis. For example, a typical turbine may include five or seven blades.

The blades are configured such that when the blades are subjected to a flowing fluid, the flowing fluid interacts with the blades to cause them to rotate. Rotation of the blades results in an internal flow of fluid through the turbine. Expulsion of the internally flowing fluid in the vicinity of the blades may further enhance the forces on the blades that cause the blades to rotate.

For convenience, the description below refers primarily to a vertical axis wind turbine (VAWT) device, and to air flow and wind. However, it should be understood that devices in accordance with embodiments of the present invention may be configured for operation when subjected to another flowing fluid. For example, embodiments of the present invention may be configured to be powered by water currents. It should also be understood that devices in accordance with some embodiments of the present invention may be configured to operate with a horizontal or oblique axis.

According to embodiments of the present invention, a vertical axis wind turbine may be configured for placement on a surface such as the ground or a roof. A central hub of the vertical axis wind turbine is typically held above the surface by a vertical post. Each blade is connected to the central hub by an arm. Each arm includes a conduit through which air may flow from the hub toward the blade. A proximal end of the conduit may connect to one or more air intake openings arranged on or near the central hub. The distal end of the conduit ends in one or more airflow outlets near the junction between the arm and the blade.

When a wind blows, the wind may aerodynamically interact with one or more of the blades to impart a tangential force to the blade. Thus, the force may cause the blades and the central hub to rotate about the vertical axis of the central hub. As a blade rotates about the central axis, air may enter the proximal end of the conduit of the attached arm through an intake opening in the vicinity of the central hub. Air in the conduit may then be accelerated as it approaches the distal end of the conduit. At the distal end of the conduit, the accelerated air may exit the conduit and the arm through one or more airflow outlets. The airflow outlets may direct the air toward the attached blade. For example, the airflow may be directed in a vertical direction parallel to a leading edge of the blade. Such a directed airflow may aerodynamically interact with other aerodynamic forces so as to enhance the tangential force on the blade. For example, the directed airflow may modify the air pressure on various sections of the blade (e.g. reduce air pressure on the leading edge of the blade), or alter patterns of air turbulence or flow on the blade.

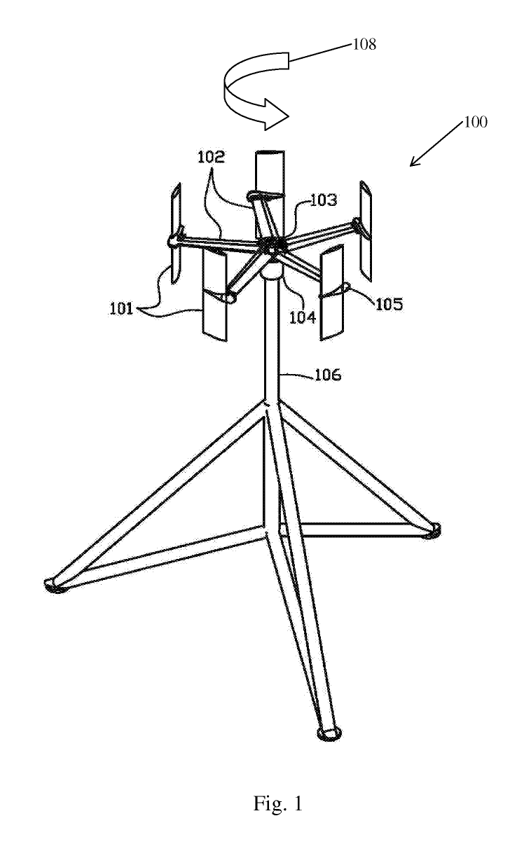

FIG. 1 shows a vertical axis wind turbine in accordance with embodiments of the present invention. Vertical axis wind turbine 100 includes blades 101. Each blade 101 is connected to a distal end of an arm 102. The proximal end of each arm 102 is connected to central hub 103. Central hub 103 is mounted on vertical post 106. Central hub 103 enables arms 102, and thus, blades 101, to rotate horizontally about an axis that is substantially coaxial with vertical post 106. For example, central hub 103 may include a bearing that enables rotation with respect to central post 106.

Each blade 101 is shaped such that relative motion between a blade 101 and flowing air or a wind creates a net tangential force on blade 101. For example, a blade 101 may be shaped in the form of a wing, as shown in FIG. 1. A net tangential force on the assembly of blades 101 may cause the assembly of blades 101 to rotate in the direction indicated by arrow 108. Alternatively, a blade may have any other shape known in the art for enabling a wind to cause a net tangential force on the assembly of blades. For example, the blades may be in the form of cups.

Rotation of blades 101 causes central hub 103 to rotate. Rotation of central hub 103 may rotate a rotor of electrical generator 104. Typically, the rotor of electrical generator 104 is rigidly coupled to central hub 103. For example, a rotatable vertical shaft may extend vertically from central hub 103 to an internal rotor of electrical generator 104, rigidly connecting central hub 103 to the rotor of electrical generator 104.

Although electrical generator 104 is illustrated in FIG. 1 as below and adjacent to central hub 103, an electrical generator may be located at any position along vertical post 106. For example, vertical post 106 may be configured to extend upward above central hub 103. Alternatively, vertical axis wind turbine 100 may include a transmission configuration for rotating the rotor of an electrical generator that is positioned to a side of vertical post 106. For example, a rotatable shaft connected to central hub 103 may extend within vertical post 106 to a gear or similar mechanism. The gear mechanism may then rotate a rotor located to the side of vertical post 106.

Typically, components of vertical axis wind turbine 100, and in particular, blades 101 and arms 102, are constructed in a manner that is suitable for a wind turbine, as is known in the art. Typically, components are constructed so as to maintain their shape when subjected to wind forces. On the other hand, moving components, such as blades 101 and arms 102, are constructed so as to minimize their weights. For example, a reinforced hollow construction may be preferred to a solid construction.

Components may typically be constructed of materials that are relatively strong and light. Examples of materials from which components may be constructed include suitable plastics, metals, ceramics, and composites.

The size of a wind turbine in accordance with embodiments of the present invention and dimensions of its components may be adapted to an intended manner of deployment. For example, a permanently installed turbine is typically larger than a turbine designed to be portable. Other factors that may effect details of the construction and configuration may include, for example, expected wind patterns and velocities, power generation requirements, safety requirements, proximity to human and wildlife populations, air and other vehicular traffic in the area, and environmental and esthetic considerations (e.g. noise generation, corrosiveness of air, disruption of scenery, ambient temperature and humidity).

Configuration of a turbine in accordance with embodiments of the present invention for a fluid other than air and wind may entail further modifications of turbine design and materials. Configuration of a turbine for use with another fluid, such as water and water currents, may require appropriate adaptations as are known in the art for the differing fluid dynamic properties of the other fluid. Such properties may include, for example, fluid density, viscosity, and velocities of fluid flows. Adaptations may include, for example, modifications to the construction and relative dimensions of the blades, arms, conduits, and openings.

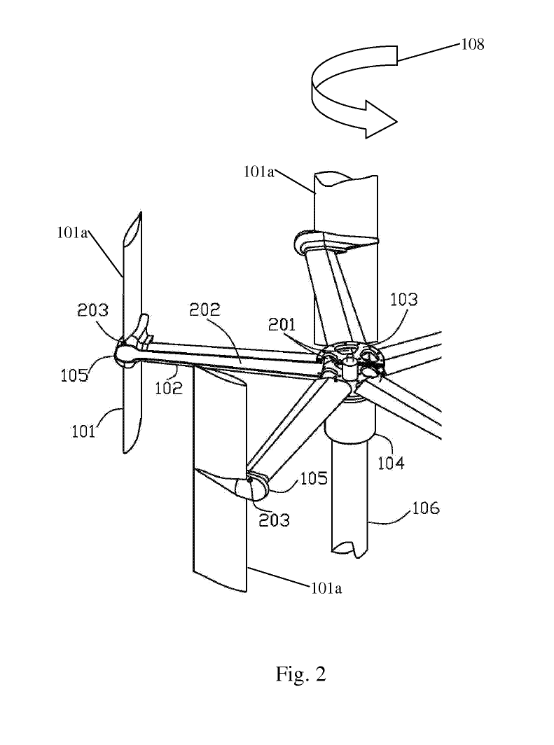

FIG. 2 is an enlarged view of a section of the vertical axis wind turbine shown in FIG. 1, illustrating details of the blade and arm structure. Central hub 103 is provided with one or more air intake openings 201. Air intake openings 201 are located near an axis of rotation about which arms 102 and blades 10 may rotate. An air intake opening 201 connects to a proximal end of an air conduit 202. Each air conduit 202 is located on a separate arm 102. A distal end of each air conduit 202 connects to an air flow distributor 105. Each air flow distributor 105 is positioned adjacent to a blade 101. Each air flow distributor 105 includes at least one air outlet opening 203. Each air outlet opening 203 is positioned such that air flowing out of each air outlet opening 203 may be directed along a leading edge 101a of the adjacent blade 101.

Each air intake opening 201 may connect separately to a separate air conduit 202. Alternatively, all or some of air intake openings 201 may open to a common air chamber that is located within central hub 103. The proximal ends of two or more of air conduits 202 may open to the common air chamber. In this manner, each air intake opening 201 may provide air to two or more of air conduits 202.

Air intake openings 201 may be located on a top or bottom surface of central hub 103, or on a vertical or diagonal wall. Alternatively, each air intake opening 201 may be located near a proximal end of an arm 102.

Typically, air intake openings 201 may be located on top and bottom surfaces of central hub 103. Air intake openings may be provided with ducts, vents, or other structure configured to direct a flow of air into air into the air intake openings.

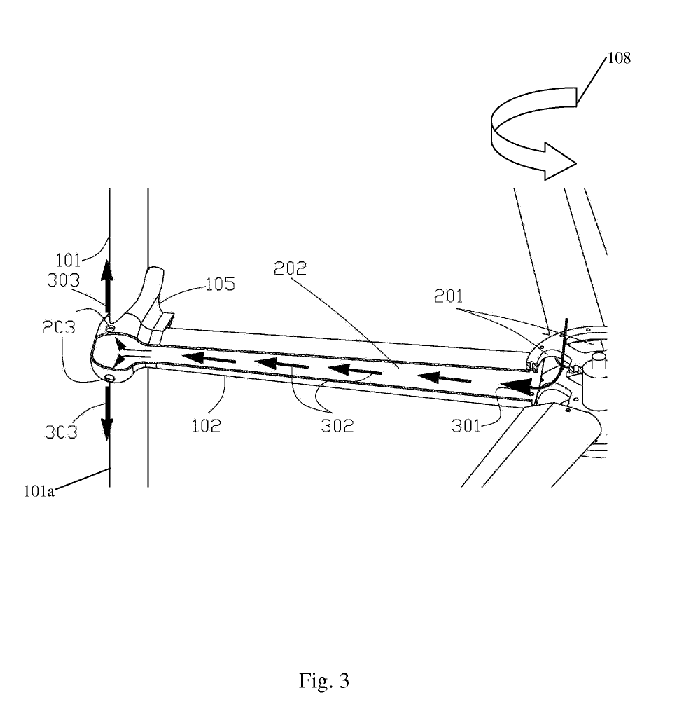

FIG. 3 is a cutaway view of the blade and arm structure shown in FIG. 2 illustrating air flow within the structure. Air that enters an air intake opening 201 from the ambient atmosphere typically flows into the proximal end of an air conduit 202. This typical flow from air intake opening 201 into air conduit 202 is indicated by flow arrow 301.

Air in air conduit 202 typically flows outwardly from the proximal end of air conduit 202 toward the distal end. This typical outward flow of air in air conduit 202 is indicated by arrows 302. Various forces may drive the air flow indicated by arrows 302. For example, rotation of a arm 102 in the direction indicated by arrow 108 may induce a centrifugal forcing of air outward through air conduit 202 toward air flow distributor 105.

Typically, each air flow distributor 105 includes at least two air outlet openings 203. For example, two air outlet openings 203 are positioned substantially opposite one another on air flow distributor 105. A force that causes air to flow outward toward the distal end of air conduit 202 may force air outward from air outlet openings 203. Outward flow of air from air outlet openings 203 is indicated by arrows 303. Typically, outward flow of air from each air outlet opening 203 is directed along, and substantially parallel to, leading edge 101a of adjacent blade 101. Thus, outward air flow from two air outlet openings 203 facing substantially opposite directions is typically directed in opposite directions along leading edge 101a of adjacent blade 101.

Outward air flow as indicated by arrows 303 may facilitate the rotational motion indicated by arrow 108. For example, the outward air flow may reduce air pressure along leading edge 101a. As another example, the outward air flow may affect patterns of air turbulence around blade 101.

It should be clear that the description of the embodiments and attached Figures set forth in this specification serves only for a better understanding of the invention, without limiting its scope.

It should also be clear that a person skilled in the art, after reading the present specification could make adjustments or amendments to the attached Figures and above described embodiments that would still be covered by the present invention.

1. A turbine device comprising:
a plurality of blades distributed about a hub and configured to rotate about an axis through the hub when subjected to a flowing fluid;
at least one fluid intake opening located near the hub;
a plurality of conduits, a proximal end of each conduit opening to said at least one fluid intake opening, each conduit extending toward a blade of said plurality of blades and each conduit including at its distal end at least one fluid outlet configured to direct a fluid flow substantially parallel to a leading edge of the blade.

2. A device as claimed in claim 1, wherein said plurality of blades comprises at least three blades.

3. A device as claimed in claim 1, wherein said plurality of blades comprises five or seven blades.

4. A device as claimed in claim 1, wherein the axis is substantially vertical.

5. A device as claimed in claim 1, wherein said plurality of blades is configured to rotate when the fluid is air.

6. A device as claimed in claim 1, wherein a fluid intake opening of said at least one fluid intake opening is located on the hub.

7. A device as claimed in claim 1, comprising a plurality of arms, each arm connecting a blade of said plurality of blades to the hub.

8. A device as claimed in claim 7, wherein each arm of said plurality of arms includes a conduit of said plurality of conduits.

9. A device as claimed in claim 1, wherein said at least one fluid outlet comprises at least two fluid outlets.

10. A device as claimed in claim 9, wherein two fluid outlets of said at least two fluid outlets are configured to direct the fluid flow in substantially opposite directions.

11. A device as claimed in claim 1, comprising an electrical generator.

12. A device as claimed in claim 11, comprising a transmission for converting rotation of the blades to rotation of a rotor of the generator.

13. A device as claimed in claim 12, wherein the transmission comprises a shaft connecting the hub to the rotor.

14. A device as claimed in claim 11, wherein the electrical generator is mounted on a post for supporting the central hub.

15. A device as claimed in claim 1, comprising a post for supporting the hub.
